(19) United States
(12) Patent Application Publication
(10) Pub. No.: US 2015/0263562 A1
(43) Pub. Date: Sep. 17, 2015

(54) EXTERNAL BATTERY

(71) Applicant: Samsung SDI Co., Ltd., Yongin-si (KR)

(72) Inventors: Gi-Young KIM, Yongin-si (KR); Jong-Chan HAN, Yongin-si (KR)

(21) Appl. No.: 14/618,870

(22) Filed: Feb. 10, 2015

(30) Foreign Application Priority Data
Mar. 13, 2014 (KR) 10-2014-0029327

(51) Int. Cl. H02J 7/00

(52) U.S. Cl. CPC H02J 7/0065; H02J 7/007; H02J 2007/0067

(57) ABSTRACT

An external battery is disclosed. In one aspect, the external battery includes an input terminal configured to receive power from an external charger, a charge current generator configured to generate a charge current based on the received power and a bare cell configured to output a voltage corresponding to the charge current. The external battery also includes a direct current to direct current (DC-DC) converter configured to convert the output voltage of the bare cell into a voltage with a different value from that of the output voltage and output the converted voltage. The external battery further includes an output terminal configured to apply the converted voltage to an external device and a main controller unit (MCU) configured to determine whether the external device is properly connected to the output terminal based at least in part on the output voltage of the bare cell.

### RELATED APPLICATIONS

This application claims priority to and the benefit of Korean Patent Application No. 10-2014-0029327, filed on Mar. 13, 2014, in the Korean Intellectual Property Office, the entire contents of which are incorporated herein by reference in their entirety.

### BACKGROUND OF THE INVENTION

1. Field of the Invention

The described technology generally relates to an external battery.

2. Description of the Related Art

Electronic devices such as notebook computers, cellular phones, personal digital assistants (PDAs) and the like have recently been developed to be portable. These portable electronic devices receive electric energy for powering the devices through batteries. The functionality of portable electronic devices is increasing such that a single portable electronic device is capable of performing several different functions in addition to its traditional functionality. This increase in functionality leads to an increase in the power consumption of portable electronic devices, and accordingly, a basic battery having a larger capacity is required. In order to meet this increased demand, portable external batteries which can be separately attached to portable electronic devices have been developed.

### SUMMARY OF THE INVENTION

One inventive aspect is an external battery that can recognize whether an external device is properly connected via a main controller unit (MCU).

Another aspect is an external battery that can recognize whether an external device is improperly connected thereto.

Another aspect is an external battery, including: a bare cell; a charge unit configured to supply, to the bare cell, external power supplied from a charger to an input stage; a direct current to direct current (DC-DC) conversion unit configured to convert an output voltage of the bare cell into a voltage with a different value from that of the output voltage, and transmit the converted voltage to an output stage connected to an external device; and a main controller unit (MCU) configured to recognize whether the external device is connected to the output stage, and decide whether the external device is normally connected to the output stage, using the output voltage of the bare cell.

The MCU may recognize whether the external device is connected to the output stage by sensing a change in voltage measured at the output stage.

The external battery may further include a first voltage sensing unit electrically connected to the bare cell, the first voltage sensing unit sensing an output voltage of the bare cell and transmitting the sensed output voltage to the MCU; and a second voltage sensing unit electrically connected to the output stage, the second voltage sensing unit sensing a voltage of the output stage and transmitting the sensed voltage to the MCU.

When the output voltage is not changed after it is recognized that the external device has been connected, the MCU may decide that the external device has not been normally connected to the output stage.

The external battery may further include a current sensing unit interposed between the DC-DC conversion unit and the output stage, the current sensing unit sensing an output current of the DC-DC conversion unit and transmitting the sensed output current to the MCU.

When the value of the sensed output current is no less than that of a predetermined over-discharge current, the MCU may decide that the external device has not been normally connected to the output stage.

The current sensing unit may include a current shunt resistor.

The external battery may further include a switch controlled by the MCU, the switch being disposed between the bare cell and the DC-DC conversion unit.

When it is decided that the external device has not been normally connected to the output stage, the MCU may disconnect the connection between the bare cell and the DC-DC conversion unit by turning off the switch.

The external battery may further include a display unit configured to display, to the exterior, whether the external device is normally connected to the output stage, which is decided by the MCU.

Another aspect is an external battery comprising an input terminal configured to receive power from an external charger; a charge current generator configured to generate a charge current based on the received power; a bare cell configured to output a voltage corresponding to the charge current; a direct current to direct current (DC-DC) converter configured to i) convert the output voltage of the bare cell into a voltage with a different magnitude from that of the output voltage and ii) output the converted voltage; an output terminal configured to apply the converted voltage to an external device; and a main controller unit (MCU) configured to determine whether the external device is properly connected to the output terminal based at least in part on the output voltage of the bare cell.

The MCU can be further configured to determine whether the external device is connected to the output terminal based at least in part on a change in voltage measured at the output terminal. The external battery can further comprise a first voltage sensor electrically connected to the bare cell and configured to i) sense the output voltage of the bare cell and ii) output the sensed output voltage to the MCU; and a second voltage sensor electrically connected to the output terminal and configured to i) sense a voltage of the output terminal and ii) output the sensed output terminal voltage to the MCU. The MCU can be further configured to recognize that the external device has not been properly connected to the output terminal when the output voltage of the bare cell does not change after the MCU has recognized that the external device is connected to the output terminal. The external battery can further comprise a current sensor connected between the DC-DC converter and the output terminal and configured to i) sense an output current of the DC-DC converter and ii) output the sensed output current to the MCU.

The MCU can be further configured to recognize that the external device is not properly connected to the output terminal when the sensed output current is greater than a predetermined threshold. The current sensor can comprise a current shunt resistor. The external battery can further comprise a switch configured to be controlled by the MCU, wherein the switch is connected between the bare cell and the DC-DC converter. The MCU can be further configured to turn off the switch so as to disconnect the bare cell from the DC-DC converter when the MCU has determined that the external device is not properly connected to the output terminal. The external battery can further comprise a display configured to display information indicative of whether the external device is properly connected to the output terminal. The output terminal can further comprise a power port and wherein the MCU is further configured to i) determine whether the voltage of the power port is in a floating state and ii) determine whether the external device is connected to the output terminal based at least in part on the determination of whether the voltage of the power port is in the floating state.

Another aspect is an external battery comprising a bare cell configured to output a voltage; an output terminal connected to the bare cell and configured to apply the received voltage to an external device; a controller configured to determine whether the external device is properly connected to the output terminal based at least in part on the output voltage of the bare cell; an input terminal configured to receive power from an external charger and supply the received power to the bare cell; and a direct current to direct current (DC-DC) converter configured to i) convert the output voltage of the bare cell into a voltage with a different value from that of the output voltage and ii) output the converted voltage to the output terminal.

The external battery can further comprise a current sensor connected between the DC-DC converter and the output terminal and configured to i) sense an output current of the DC-DC converter and ii) output the sensed output current to the controller. The controller can be further configured to recognize that the external device has not been properly connected to the output terminal when the output voltage of the bare cell does not change after the controller has determined that the external device is connected to the output terminal. The external battery can further comprise a switch configured to be controlled by the controller, wherein the switch is connected between the bare cell and the DC-DC converter. The controller can be further configured to turn off the switch so as to disconnect the bare cell from the DC-DC converter when the controller has determined that the external device is not properly connected to the output terminal. The controller can be further configured to determine whether the external device is connected to the output terminal based at least in part on a change in voltage measured at the output terminal. The external battery can further comprise a first voltage sensor electrically connected to the bare cell and configured to i) sense the output voltage of the bare cell and ii) output the sensed output voltage to the controller; and a second voltage sensor electrically connected to the output terminal and configured to i) sense a voltage of the output terminal and ii) output the sensed output terminal voltage to the controller. The output terminal can comprise a power port and wherein the controller is further configured to i) determine whether the voltage of the power port is in a floating state and ii) determine whether the external device is connected to the output terminal based at least in part on the determination of whether the voltage of the power port is in the floating state.

According to at least one embodiment, the external battery can recognize that an external device is improperly connected thereto and display the improper connection to a user, so that the external device can be correctly charged.

### BRIEF DESCRIPTION OF THE DRAWINGS

FIG. 1 is a block diagram schematically showing the configuration of a standard external battery.

FIG. 2 is a block diagram showing an external battery according to an embodiment.

FIG. 3 is a block diagram showing an external battery according to another embodiment.

### DETAILED DESCRIPTION OF THE PREFERRED EMBODIMENT

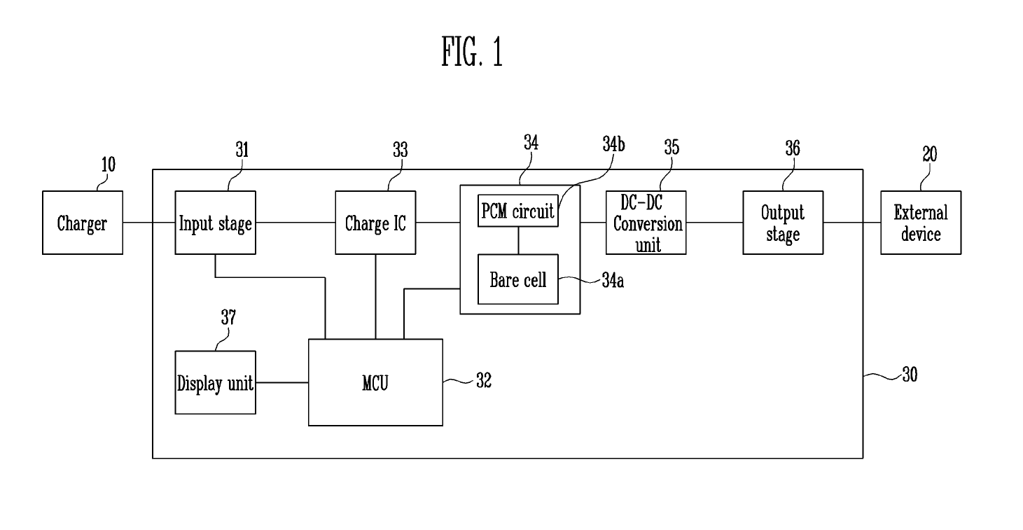

Referring to FIG. 1, the standard external battery 30 includes an input stage 31 that receives external power supplied from a charger 10. A main controller unit (MCU) 32 detects the type of charger, e.g., the characteristics of the received power, by sensing the voltage of the input stage or input terminal 31 and controls the output current of a charge integrated circuit (IC) 33. The charge IC 33 supplies the output current to a battery 34. The MCU 32 senses the voltage of the battery 34 and displays the remaining charge of the battery 34 through a display unit 37. The voltage output from the battery 34 is boosted through a direct current to direct current (DC-DC) conversion unit 35 where it can be supplied to an external device 20 connected to an output stage or output terminal 36.

When connected to the output stage 36, the external device 20 does not transmit a signal to the external battery 30 indicating the type of external device. Accordingly, the external battery 30 can take action to recognize the type or specification. However, even when the external battery 30 recognizes that the external device 20 has been connected to the output terminal 36, the external battery 30 may not be properly connected to the external device 20, resulting in improper or absence of charging.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the embodiments to those skilled in the art.

In the drawings, dimensions may be exaggerated for clarity of illustration. It will be understood that when an element is referred to as being “between” two elements, it can be the only element between the two elements, or one or more intervening elements may also be present. Like reference numerals refer to like elements throughout.

In the following detailed description, only certain exemplary embodiments have been shown and described, simply by way of illustration. As those skilled in the art would realize, the described embodiments may be modified in various different ways, all without departing from the spirit or scope of the described technology. Accordingly, the drawings and description are to be regarded as illustrative in nature and not restrictive. In addition, when an element is referred to as being on another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements.

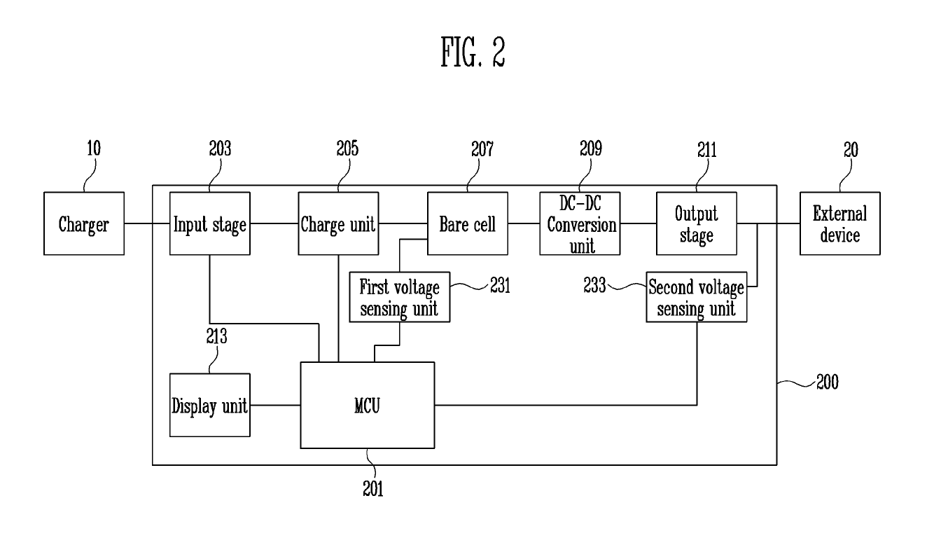

Referring to FIG. 2, the external battery 200 includes a main controller unit (MCU) or controller 201, an input stage 203, a charge unit or charge current generator 205, a bare cell 207, a DC-DC conversion unit or DC-DC converter 209 and an output stage 211.

The MCU 201 controls the components of the external battery 200. Hereinafter, the operation of the MCU 201 will be described in detail together with the other components.

The input stage 203 is connected to a terminal of a charger 10, and transmits, to the charge unit 205, external power received from the charger 10. The input stage 203 may be implemented in various forms according to the properties of the charger 10.

The charge unit 205 generates charge current, using external power received from the input stage 203, and then supplies the generated charge current to the bare cell 207, thereby charging the bare cell 207. The maximum charge current output from the charge unit 205 may be changed depending on the type of the charger 10 connected to the input stage 203. Thus, the MCU 201 can detect the specifications of the charger 10 by sensing the voltage at the input stage 203 and control the charge unit 205 so that the maximum charge current based on the specifications of the charger 10 is output from the charge unit 205.

The bare cell 207 is a rechargeable battery cell sealed inside a battery case. The bare cell 207 includes an electrode assembly having a positive electrode/separator/negative electrode structure immersed in a lithium electrolyte. Electrode assemblies are generally classified into jelly-roll type (winding type) electrode assemblies and stacking type electrode assemblies. Jelly-roll type (winding type) electrode assemblies can be formed by winding long sheet-shaped positive and negative electrodes, each having an active material coated on both surfaces thereof, with a separator interposed between the positive and negative electrodes. Stacking type electrode assemblies can be formed by sequentially stacking a plurality of positive and negative electrodes having a predetermined size, each having an active material coated on both surfaces thereof, with a separator interposed between the positive and negative electrodes.

The bare cell 207 may include cylindrical and/or prismatic bare cells in which an electrode assembly is accommodated in a battery case such as a metal can. In other embodiments, the bare cell 207 includes a pouch-type bare cell in which an electrode assembly is accommodated in a battery case formed of an aluminum laminate sheet. The bare cell 207 may have a structure in which two or more bare cells are connected in series and/or parallel.

The DC-DC conversion unit 209 converts the voltage output from the bare cell 207 into a voltage for driving an external device 20 and transmits the converted voltage to the output stage 211.

The output stage 211 can be connected to the external device 20 and transmits, to the external device 20, electric power received from the bare cell 207. The output stage 211 may be implemented in various forms based on the external device 20 to be connected thereto.

A display unit 213 displays the capacity of the bare cell 207. The MCU 201 can calculate the remaining capacity of the bare cell 207 using the voltage of the bare cell 207 and control the display unit 213 to display the calculated remaining capacity.

A first voltage sensing unit or first voltage sensor 231 is electrically connected to the bare cell 207. The first voltage sensing unit 231 senses the output voltage of the bare cell 207 and transmits the sensed output voltage to the MCU 201.

A second voltage sensing unit or second voltage sensor 233 is electrically connected to the output stage 211. The second voltage sensing unit 233 senses the voltage of the output stage 211 and transmits the sensed voltage to the MCU 210.

According to an embodiment, the MCU 201 recognizes when the external device 20 is connected to the output terminal 211 and decides whether the external device 20 is normally or properly connected to the external battery 200 based on the output voltage of the bare cell 207.

When the external device 20 is connected to the output stage 211, the voltage of the output stage 211 is instantaneously changed. For example, when the external device 20 is connected to a terminal of the output stage 211, the voltage of the output stage 211 is changed. Thus, the MCU 201 recognizes whether the external device 20 is connected to the external battery 200 by sensing a change in voltage measured in the output stage 211.

In some embodiments, the external device 20 includes a universal serial bus (USB) terminal including power and data pins configured to be connected to the output stage 211. The output stage 211 may include a power port connected to the power pin and a data port connected to the data pin.

In these embodiments, when the power pin of the external device 20 is connected to the power port of the output stage 211, the voltage of the power port transitions to a floating state, and the MCU 201 recognizes that the external device 20 has been connected to the external battery 200 by detecting the floating state of the power port.

According to an embodiment, when the external device 20 has been recognized as connected to the external device 20, the MCU 201 senses whether the output voltage of the bare cell 207 has changed. When the output voltage of the bare cell 207 has not changed, the MCU 201 determines that the external device 20 is not normally connected to the external battery 200.

For example, when a USB cable is connected to the output stage 211 without being connected to the external device 20 or when the external device 20 is improperly connected to the USB cable, the output voltage of the bare cell 207 cannot be transmitted to the external device 20 through the output stage 211. In these situations, a user may believe that the external device 20 has been properly connected to the output stage 211 of the external battery 200 and expects that the external device 20 will be charged. However, the external device 20 is not actually charged due to the improper connection described above.

Thus, according to at least one embodiment, when the output voltage of the bare cell 207 does not change when the external device is connected to the output stage 211, i.e., when discharge of the bare cell 207 is not performed even though the external device 20 is connected to the output stage 211, the MCU 201 can recognize this as an improper connection of the external device 20 and displays information indicative of the improper connection through the display unit 213.

The display unit 213 may be implemented with a display device to display information such an improper connection via text or an image to a user. In other embodiments, the display unit 213 displays the improper connection through flickering of a light-emitting diode (LED). In addition, the display unit 213 may be implemented in various forms to display the improper connection of the external device 20.

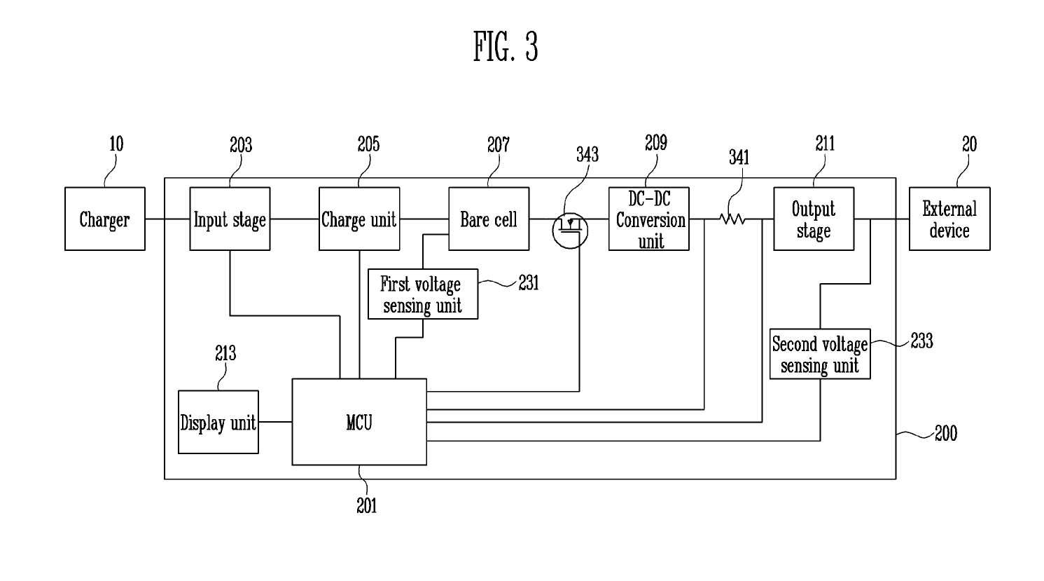

FIG. 3 is a block diagram showing an external battery according to another embodiment.

Components of the external battery 200 shown in FIG. 3 are identical to those of the external battery 200 shown in FIG. 2, except for a current sensing unit or current sensor 341 and a switch 343, and therefore, detailed descriptions of the identical components will be omitted to avoid redundancy.

Referring to FIG. 3, the current sensing unit 341 is interposed between the DC-DC conversion unit 209 and the output stage 211. The current sensing unit 341 senses current output from the DC-DC conversion unit 209 and transmits the sensed current to the MCU 201. As shown in FIG. 3, the current sensing unit 341 may include a current shunt resistor.

When a short circuit occurs between the terminal of the output stage and the USB terminal of the external device 20 due to the improper connection of the external device 20 connected to the output stage 211, there is a risk that the output current may suddenly increase.

Accordingly, when the magnitude of output current sensed in the current sensing unit 341 is greater than a predetermined over-discharge current, the MCU 201 determines that the external device 20 is improperly connected. Subsequently, the MCU 201 disconnects the connection between the bare cell 207 and the DC-DC conversion unit 209 by turning off the switch 343 interposed therebetween so that it is possible to protect the external battery 200.

Although the switch 343 may be implemented with a transistor as shown in FIG. 3, the described technology is not limited thereto.

As described above, the external battery according to at least one embodiment recognizes when an external device is improperly connected to the external battery and displays information indicative of the improper connection. Accordingly, a user can recognize the occurrence of the improper connection in order to correct the connection such that the external device can be charged.

Example embodiments have been disclosed herein, and although specific terms are employed, they are used and are to be interpreted in a generic and descriptive sense only and not for the purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An external battery, comprising:
an input terminal configured to receive power from an external charger;
a charge current generator configured to generate a charge current based on the received power;
a bare cell configured to output a voltage corresponding to the charge current;
a direct current to direct current (DC-DC) converter configured to i) convert the output voltage of the bare cell into a voltage with a different magnitude from that of the output voltage and ii) output the converted voltage;
an output terminal configured to apply the converted voltage to an external device; and
a main controller unit (MCU) configured to determine whether the external device is properly connected to the output terminal based at least in part on the output voltage of the bare cell.

2. The external battery of claim 1, wherein the MCU is further configured to determine whether the external device is connected to the output terminal based at least in part on a change in voltage measured at the output terminal.

3. The external battery of claim 1, further comprising:
a first voltage sensor electrically connected to the bare cell and configured to i) sense the output voltage of the bare cell and ii) output the sensed output voltage to the MCU; and
a second voltage sensor electrically connected to the output terminal and configured to i) sense a voltage of the output terminal and ii) output the sensed output terminal voltage to the MCU.

4. The external battery of claim 3, wherein the MCU is further configured to recognize that the external device has not been properly connected to the output terminal when the output voltage of the bare cell does not change after the MCU has recognized that the external device is connected to the output terminal.

5. The external battery of claim 1, further comprising a current sensor connected between the DC-DC converter and the output terminal and configured to i) sense an output current of the DC-DC converter and ii) output the sensed output current to the MCU.

6. The external battery of claim 5, wherein the MCU is further configured to recognize that the external device is not properly connected to the output terminal when the sensed output current is greater than a predetermined threshold.

7. The external battery of claim 5, wherein the current sensor comprises a current shunt resistor.

8. The external battery of claim 6, further comprising a switch configured to be controlled by the MCU, wherein the switch is connected between the bare cell and the DC-DC converter.

9. The external battery of claim 8, wherein the MCU is configured to turn off the switch so as to disconnect the bare cell from the DC-DC converter when the MCU has determined that the external device is not properly connected to the output terminal.

10. The external battery of claim 1, further comprising a display configured to display information indicative of whether the external device is properly connected to the output terminal.

11. The external battery of claim 1, wherein the output terminal comprises a power port and wherein the MCU is further configured to i) determine whether the voltage of the power port is in a floating state and ii) determine whether the external device is connected to the output terminal based at least in part on the determination of whether the voltage of the power port is in the floating state.
